(19) United States
(12) Patent Application Publication
(10) Pub. No.: US 2026/0154458 A1
(43) Pub. Date: Jun. 4, 2026

(54) APPARATUS AND METHOD OF VERIFYING FACTUALITY OF DOCUMENT

(71) Applicant: ELECTRONICS AND TELECOMMUNICATIONS RESEARCH INSTITUTE, Daejeon (KR)

(72) Inventors: Minho Kim, Daejeon (KR); Jihyeon Roh, Daejeon (KR); Kyungman Bae, Daejeon (KR); HyunKi Kim, Daejeon (KR); YONGJIN BAE, Daejeon (KR); Hyung Jik Lee, Daejeon (KR); Myung Gil JANG, Daejeon (KR)

(21) Appl. No.: 19/323,491

(22) Filed: Sep. 9, 2025

(30) Foreign Application Priority Data
Dec. 3, 2024 (KR) 10-2024-0177180

(51) Int. Cl. G06F 21/64; G06F 16/334; G06F 40/166; G06F 40/30

(52) U.S. Cl. CPC G06F 21/64; G06F 16/3344; G06F 40/166; G06F 40/30

(57) ABSTRACT

A factuality verification apparatus includes an input module configured to receive a written document, a filtering module configured to filter an untargeted sentence, which does not correspond to a target for factuality verification, a selection module configured to respectively divide a plurality of individual facts of one sentence into different sentences to generate atomic sentences respectively corresponding to the plurality of individual facts and select a core atomic sentence corresponding to a sentence including the fact-related content associated with the subject among the atomic sentences, and a verification module configured to perform factuality verification on whether the core atomic sentence is true or not, through comparison of the core atomic sentence and an evidence document capable of checking whether content of the core atomic sentence is true or false.

### CROSS-REFERENCE TO RELATED APPLICATION(S)

This application claims the benefit of the Korean Patent Application No. 10-2024-0177180 filed on Dec. 3, 2024, which is hereby incorporated by reference as if fully set forth herein.

### BACKGROUND

### 1. Field of the Invention

The present disclosure relates to technology for verifying factuality of a document, and more particularly, to a method which may extract a core atomic sentence on a generated document to verify factuality of each core atomic sentence and an apparatus for supporting the method.

### 2. Description of Related Art

As large language model technology advances, factuality verification technology is increasing more in importance. This is because the use of large language models is generalized, and thus, a very large number of texts are more and more generated. Particularly, due to an inherent problem such as hallucination, large language models may generate factually incorrect text.

In factuality verification technology, fundamental core pipelines have been well defined through much research. For example, when a sentence is given, factuality verification technology searches for a document (or paragraph) containing relevant facts and determines the factuality of the given sentence based on the retrieved document.

Furthermore, large language models refuse generation to a user because of a safety issue or abandon generation on content which a corresponding language model does not know well. In this case, large language models write the content in texts to provide to a user. Also, large language models write speculative content or generate a very large number of kinds of non-factual sentences such as providing a stereotype answer, which is not based on a fact, to a related characteristic (for example, ‘detailed information about Ptious is not provided.’, ‘it is impossible to provide a real history of Piyassilis.’, ‘if you ask about famous Aribas for a particular field, if you give us some more detailed information, we can give a proper answer.’, ‘but, if the ques mentioned in this question is an openly known famous celebrity or a public figure, unfortunately, he isn't come up with as the person who we can provide a detailed profile about it by the information generated until 2023.’, ‘as of 2023, if Xiao Zhenghao is a person who was involved in an information event or achieved a notable achievement in a particular field, the information about him can be released additionally.’, ‘if you find the person who work in a particular field or a concept, if you provide some more detailed information to us, we can help you.’, etc.).

Such non-factual sentences are not targeted for factuality verification, and thus, should be excluded before factuality verification is performed. However, expression forms thereof are very various. Particularly, in Korean language, an expression form of the same content may be very various based on an arbitrary sequence, an arbitrary postpositional particle, and an arbitrary ending which are used. Therefore, it is actually impossible to exclude a corresponding sentence by simply searching for a pattern. That is, in order to process such a problem, a function of separately processing the problem is needed, and this has been missed in conventional factuality verification technology.

Moreover, factuality verification technology should be capable of verification even when only a portion of a sentence instead of a whole sentence unit include non-factual content, but a method for solving such a problem has not been provided in conventional technology.

### PRIOR ART REFERENCE

### Patent Document

(Patent Document 1) Korean Patent Publication No. 10-2020-0045657

### SUMMARY

An aspect of the present disclosure is directed to providing technology which may verify factuality by selecting core atomic sentence in a written document through a method of filtering a non-factual sentence of the written document so as to solve problems of conventional technologies.

Another aspect of the present disclosure is directed to providing a method which may distinguish non-factual sentences of various purposes and forms and may filter out sentences that are not targets of factuality verification in the type of an extracted atomic sentence as well as an original sentence of an input written document so as to process the diversity of expressions based on transformation of unique sequence of words, postpositional particle, and ending, especially in Korean language, and thus, may perform accurate factuality verification.

The objects of the present invention are not limited to the aforesaid, but other objects not described herein will be clearly understood by those skilled in the art from descriptions below.

To achieve these and other advantages and in accordance with the purpose of the invention, as embodied and broadly described herein, there is provided a factuality verification apparatus performing factuality verification of a document, the factuality verification apparatus including an input module configured to receive a written document, a filtering module configured to filter an untargeted sentence, which does not correspond to a target for factuality verification, in sentences of the written document and a sentence including non-factual content associated with a subject of the written document, a selection module configured to respectively divide a plurality of individual facts of one sentence into different sentences to generate atomic sentences respectively corresponding to the plurality of individual facts and select a core atomic sentence corresponding to a sentence including the fact-related content associated with the subject among the atomic sentences, and a verification module configured to perform factuality verification on whether the core atomic sentence is true or not, through comparison of the core atomic sentence and an evidence document capable of checking whether content of the core atomic sentence is true or false.

Moreover, in embodiments of the present disclosure, the selection module may include an atomic sentence generation module configured to respectively divide, into different sentences, individual facts of each sentence except the untargeted sentence among the sentences of the written document to generate an atomic sentence corresponding to each of the individual facts; and a core atomic sentence selection module configured to select the core atomic sentence from among atomic sentences.

Moreover, in embodiments of the present disclosure, the evidence document may be a knowledge document corresponding to a document or a paragraph for factuality verification and may be obtained through a knowledge storage.

Moreover, in embodiments of the present disclosure, the factuality verification apparatus may further include a correction module configured to, when a falsity or an error of the core atomic sentence is determined as a factuality verification result of whether the core atomic sentence is true or not, correct a portion corresponding to the falsity or error, based on the evidence document, and generate a corrected document of the written document, based on a correction-reflected core atomic sentence.

Moreover, in embodiments of the present disclosure, the verification module may transmit, to the knowledge storage, request information which requests information associated with factuality verification of the core atomic sentence, and the knowledge storage may search for the evidence document, based on the request information, and may transmit, to the verification module, at least one paragraph or document having a similarity to the core atomic sentence as a result of the search.

Moreover, in embodiments of the present disclosure, the request information may include at least one of the core atomic sentence or a keyword of the written document.

Moreover, in embodiments of the present disclosure, the knowledge storage may select a certain number of paragraphs or documents in descending order of similarities through reranking where priorities are again sorted on the at least one paragraph or document, based on the similarity.

Moreover, in embodiments of the present disclosure, the factuality verification apparatus may combine factuality verification results of the core atomic sentence to calculate a factuality score of the written document.

Moreover, in embodiments of the present disclosure, the factuality score may be calculated by dividing, by the total number of core atomic sentences, the number of core atomic sentences which are ‘true’ as the factuality verification result.

Moreover, in embodiments of the present disclosure, the verification module may use a language model-based verification model or a machine learning-based verification model.

Moreover, in embodiments of the present disclosure, the selection module may exclude the untargeted sentence and may select the core atomic sentence, and the untargeted sentence may be a sentence which proposes additional information search, a sentence which requests additional information, a sentence associated with the abandonment or refusal of answering, a sentence corresponding to a stereotype answer to a characteristic related to a subject because it is unable to assure correct information, a sentence corresponding to speculative content, or a sentence including subjective or qualitative evaluation.

In another aspect of the present invention, there is provided a factuality verification method of performing factuality verification of a document, the factuality verification method including: a step of receiving a written document; a step of filtering an untargeted sentence, which does not correspond to a target for factuality verification, in sentences of the written document and a sentence including non-factual content associated with a subject of the written document; a step of respectively dividing a plurality of individual facts of one sentence into different sentences to generate atomic sentences respectively corresponding to the plurality of individual facts and selecting a core atomic sentence corresponding to a sentence including the fact-related content associated with the subject among the atomic sentences; and a step of performing factuality verification on whether the core atomic sentence is true or not, through comparison of the core atomic sentence and an evidence document capable of checking whether content of the core atomic sentence is true or false.

Moreover, in embodiments of the present disclosure, the factuality verification method may further include: when a falsity or an error of the core atomic sentence is determined as a factuality verification result of whether the core atomic sentence is true or not, a step of correcting a portion corresponding to the falsity or error, based on the evidence document; and generating a corrected document of the written document, based on a correction-reflected core atomic sentence.

Moreover, in embodiments of the present disclosure, the factuality verification method may further include: a step of transmitting, to a knowledge storage, request information which requests information associated with factuality verification of the core atomic sentence; a step of searching for the evidence document, based on the request information; and a step of receiving, from a knowledge storage, at least one paragraph or document having a similarity to the core atomic sentence as a result of the search.

Moreover, in embodiments of the present disclosure, the searching step may include: a step of performing reranking where priorities are again sorted on the at least one paragraph or document, based on the similarity; and a step of selecting a certain number of paragraphs or documents in descending order of similarities.

Moreover, in embodiments of the present disclosure, the factuality verification method may further include a step of combining factuality verification results of the core atomic sentence to calculate a factuality score of the written document.

Moreover, in embodiments of the present disclosure, the factuality score may be calculated by dividing, by the total number of core atomic sentences, the number of core atomic sentences which are ‘true’ as the factuality verification result.

Moreover, in embodiments of the present disclosure, the step of selecting the core atomic sentence may include a step of excluding the untargeted sentence.

Moreover, in embodiments of the present disclosure, the untargeted sentence may be a sentence which proposes additional information search, a sentence which requests additional information, a sentence associated with the abandonment or refusal of answering, a sentence corresponding to a stereotype answer to a characteristic related to a subject because it is unable to assure correct information, a sentence corresponding to speculative content, or a sentence including subjective or qualitative evaluation.

The present disclosure may distinguish non-factual sentences of various purposes and forms by selecting core atomic sentence in a written document through a method of filtering a non-factual sentence of the written document and may process the diversity of expressions based on transformation of unique vocabulary sequence, postpositional particle, and ending like Korean language.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 illustrates an example of an internal block diagram of a factuality verification apparatus according to an embodiment of the present disclosure.

FIG. 2 illustrates an example of an internal block diagram of a selection module according to an embodiment of the present disclosure.

FIG. 3 illustrates an example of an entire algorithm performing factuality verification of a written document based on a core atomic sentence according to an embodiment of the present disclosure.

FIG. 4 illustrates an example of a search process including reranking according to an embodiment of the present disclosure.

FIG. 5 illustrates an example of a method of generating a factuality verification result-based corrected document according to an embodiment of the present disclosure.

FIG. 6 illustrates an example of another method of performing factuality verification of a written document according to an embodiment of the present disclosure.

FIG. 7 is a diagram illustrating an example of a method of immediately extracting a core atomic sentence in a written document to perform factuality verification according to an embodiment of the present disclosure.

FIG. 8 is a flowchart illustrating another example of a method of performing factuality verification of a document according to an embodiment of the present disclosure.

### DETAILED DESCRIPTION OF THE INVENTION

The terminology used herein is for the purpose of describing particular embodiments only and is not intended to be limiting of the invention. Unless otherwise defined, all terms used herein have the same meaning as commonly understood by one of ordinary skill in the art to which this invention pertains and should not be interpreted as having an excessively comprehensive meaning nor as having an excessively contracted meaning. If technical terms used herein is erroneous that fails to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

It will be understood that although the terms including an ordinary number such as first or second are used herein to describe various elements, these elements should not be limited by these terms. These terms are only used to distinguish one element from another element. For example, a first element may be referred to as a second element without departing from the spirit and scope of the present invention, and similarly, the second element may also be referred to as the first element. In the following description, the technical terms are used only for explaining a specific embodiment while not limiting the present invention. The terms of a singular form may include plural forms unless referred to the contrary.

Hereinafter, embodiments described in the present disclosure will be described in detail with reference to the accompanying drawings, like reference numerals refer to like or similar elements regardless of reference numerals, and their repeated descriptions are omitted.

Moreover, in describing technology described in the present disclosure, when it is determined that detailed descriptions of related technology known to those of ordinary skill in the art obscure the gist of technology described in the present disclosure, the detailed descriptions are omitted. Also, the accompanying drawings are merely for helping easily understand the inventive concept described in the present disclosure, and it should not be construed that the accompanying drawings limit the inventive concept.

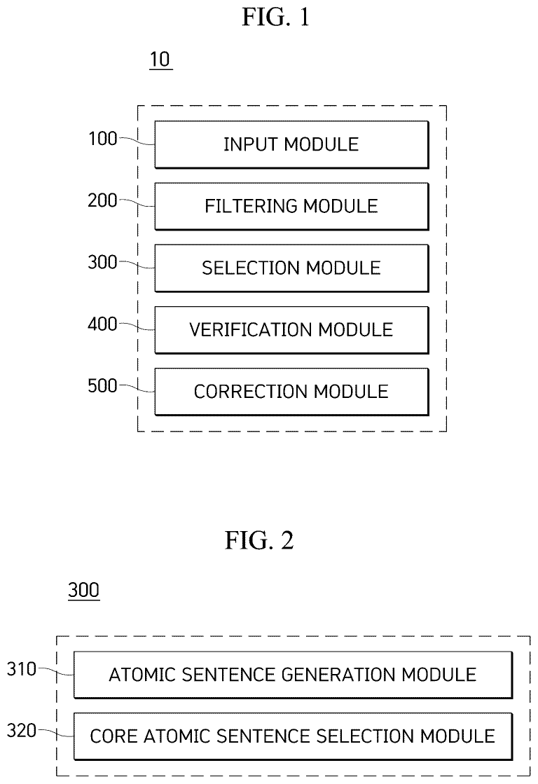

FIG. 1 illustrates an example of an internal block diagram of a factuality verification apparatus 10 according to an embodiment of the present disclosure.

Referring to FIG. 1, the factuality verification apparatus 10 may include an input module 100, a filtering module 200, a selection module 300, a verification module 400, and a correction module 500.

The input module 100 may receive a written document.

The filtering module 200 may filter an untargeted sentence which does not correspond to a target of factuality verification, in sentences of the written document.

Here, the untargeted sentence may denote a sentence which does not include fact-related content associated with a subject of the written document.

The untargeted sentence may be a sentence which proposes additional information search, a sentence which requests additional information, a sentence associated with the abandonment or refusal of answering, a sentence corresponding to a stereotype answer to a characteristic related to a subject because it is unable to assure correct information, a sentence corresponding to speculative content, or a sentence including subjective or qualitative evaluation, and a detailed example will be described below.

The selection module 300 may divide a plurality of individual facts of one sentence into different sentences to generate atomic sentences respectively corresponding to the individual facts and may select a core atomic sentence corresponding to a sentence including fact-related content associated with the subject among the atomic sentences.

The selection module 300 may additionally perform a process of excluding or filtering an untargeted sentence performed by the filtering module 200 to select a core atomic sentence.

Referring to FIG. 2, the selection module 300 may include an atomic sentence generation module 310 and a core atomic sentence selection module 320. FIG. 2 illustrates an example of an internal block diagram of a selection module according to an embodiment of the present disclosure.

The atomic sentence generation module 310 may divide, into different sentences, individual facts of each sentence except an untargeted sentence among sentences of a written document to generate an atomic sentence corresponding to each of the individual facts.

The core atomic sentence selection module 320 may select a core atomic sentence from among atomic sentences.

The verification module 400 may perform factuality verification on whether the core atomic sentence is true or not, through comparison of the core atomic sentence and an evidence document capable of checking whether content of the core atomic sentence is true or false.

The evidence document may be a knowledge document corresponding to a document or a paragraph for factuality verification and may be included in the factuality verification apparatus or may be obtained through a knowledge storage provided in the outside separately from the verification apparatus.

The verification module may transmit, to the knowledge storage, request information which requests information associated with factuality verification of the core atomic sentence, and the knowledge storage may search for the evidence document, based on the request information and may transmit, to the verification module, at least one paragraph or document having a similarity to the core atomic sentence as a result of the search.

The verification module may perform factuality verification by using a language model-based verification model or a machine learning-based verification model.

The request information may include at least one of the core atomic sentence or a keyword of the written document.

Moreover, the knowledge storage may select a certain number of paragraphs or documents in descending order of similarities through reranking where priorities are again sorted on the at least one paragraph or document, based on the similarity.

When a falsity or an error of the core atomic sentence is determined as a factuality verification result of whether the core atomic sentence is true or not, the correction module 500 may correct a portion corresponding to the falsity or error, based on the evidence document, and may generate a corrected document of the written document, based on a correction-reflected core atomic sentence.

Additionally, the factuality verification apparatus may combine factuality verification results of core atomic sentences to calculate a factuality score of a written document, and the factuality score may be calculated by dividing, by the total number of core atomic sentences, the number of core atomic sentences which are ‘true’ as the factuality verification result.

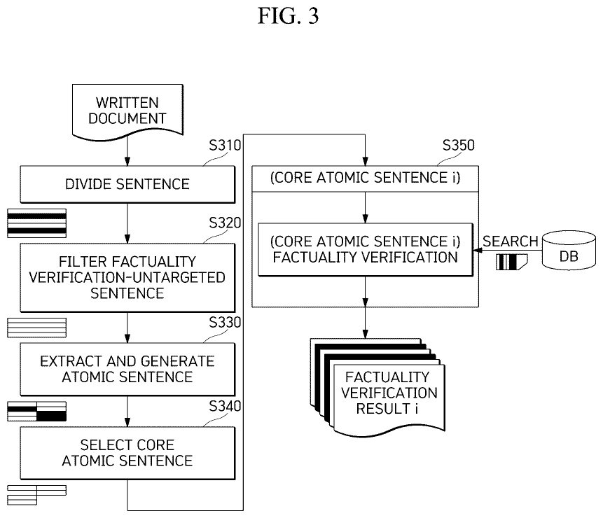

FIG. 3 illustrates an example of an entire algorithm performing factuality verification of a written document based on a core atomic sentence according to an embodiment of the present disclosure.

First, the factuality verification apparatus may receive a written document through an input module. The written document may be a document which is written by a person or is generated by a machine. For example, the written document may be a document which is generated by commanding a machine such as ChatGPT to generate a history of an arbitrary person. The following Table 1 may show an example of a document generated by ChatGPT.

TABLE 1
Kwon Young-guil is one of the representative people for progressive politics as a Korean
politician.
He is from Daegu, He was born 26th Feb. 1945. His political career is remarkable by
working in a variety of progressive parties, especially, he played activities related to labor
movement actively. From the late of 1980s, he started political activity, he was nominated for
the president of Korean Democratic Labor Party as a first member of the Party.
He was nominated for series of a member of National Assembly in 2000 and 2004. In 2004, in
the 17th general election, having been elected member of National Assembly as a member of
Korean Democratic Labor Party, he achieved unexpected success as a member of progressive
party.
Kwon Young-guil have taken an effort for the progressive value, but there is no information
provided about detailed newest information or any activities for him.
So, it is recommended to search for additional information about his recent background or
activities.

Moreover, when a written document is received, the factuality verification apparatus may divide the received written document by units of sentence by using a division module in step S310. The following Table 2 may show an example where a document is divided by units of sentence.

TABLE 2
Kwon Young-guil is one of the representative people for progressive politics as a Korean
politician.
He is from Daegu, He was born 26th Feb. 1945. His political career is remarkable by
working in a variety of progressive parties, especially, he played activities related to labor
movement actively. From the late of 1980s, he started political activity, he was nominated for
the president of Korean Democratic Labor Party as a first member of the Party.
He was nominated for series of a member of National Assembly in 2000 and 2004. In 2004, in
the 17th general election, having been elected member of National Assembly as a member of
Korean Democratic Labor Party, He achieved unexpected success as a member of progressive
party.
Kwon Young-guil have taken an effort for the progressive value, but there is no information
provided about detailed newest information or any activities for him.
So, it is recommended to search for additional information on his recent background or
activities.

Referring to Table 2, sentences which do not include fact-related content on a subject may be included in a divided sentence. For example, there may be a sentence “it is recommended to search for additional information on his recent background or activities” in a sentence list of Table 2. Such sentences should be removed because of not being a target factuality verification. Such a filtering process may be performed through the filtering module (or an untargeted sentence filtering module) of the factuality verification apparatus. That is, the factuality verification apparatus may filter an untargeted sentence irrelevant to factuality verification in step S320. The filtering module may be a model using an artificial intelligence network such as a language model.

To perform the filtering process, a language meaning of a sentence should be understood, and the infactuality of a sentence should be determined. Such a function may be effective when a language model is used, and particularly, may be performed through a model based on a fine-tuning process or instruction tuning.

Moreover, the factuality verification apparatus may extract an atomic sentence through an extraction module in step S330. Here, the atomic sentence may be a sentence which is generated by dividing individual content (or facts) capable of being included in one sentence. The individual content may be divided into separate sentences. The following Table 3 may show an example which extracts an atomic sentence.

TABLE 3
(Original sentence)
Kwon Young-guil is one of the representative people for progressive politics as a Korean
politician.
(Atomic sentences)
Kwon Young-guil is a Korean politician.
Kwon Young-guil is one of the representative people for progressive politics.
(Original sentence)
From the late of 1980s, he started political activity, he assumed the president of Korean
Democratic Labor Party as a first member of the Party.
(Atomic sentences)
From the late of 1980s, he started political activity.
He was a first member of Korean Democratic Labor Party.
He assumed the president of the Party.
(Original sentences)
Kwon Young-guil have taken an effort for the progressive value, but there is no information
provided about detailed newest information or any activities for him.
(Atomic sentences)
Kwon Young-guil have taken an effort for the progressive value.
There is no detailed newest information for Kwon Young-guil.
There is no information provided about any activities for Kwon Young-guil.

Moreover, the factuality verification apparatus may select a core atomic sentence by using the selection module in step S340. Here, the core atomic sentence may denote only a sentence which includes individual facts and includes fact-related content on a subject. That is, the factuality verification apparatus may select only a core atomic sentence on a given input. The factuality verification apparatus may remove an atomic sentence including non-factual content on a subject of a document similarly to filtering of a factuality verification-untargeted sentence performed by the filtering module described above and may select only a core atomic sentence. The following Table 4 may show an example which selects a core atomic sentence.

TABLE 4
(Atomic sentences)
Kwon Young-guil is a Korean politician.
Kwon Young-guil is one of the representative people for progressive
politics.
From the late of 1980s, he started political activity.
He was a first member of Korean Democratic Labor Party.
He assumed the president of the Party.
Kwon Young-guil have taken an effort for the progressive value.
There is no detailed newest information for Kwon Young-guil.
There is no information provided about any activities for Kwon
Young-guil.
(Core atomic sentences)
Kwon Young-guil is a Korean politician.
Kwon Young-guil is one of the representative people for progressive
politics.
From the late of 1980s, he started political activity.
He was a first member of Korean Democratic Labor Party.
he assumed the president of the Party.
Kwon Young-guil have taken an effort for the progressive value.

Moreover, the factuality verification apparatus may perform factuality verification on each core atomic sentence i by using the verification module in step S350. Here, i may denote a natural number within a range from one to the total number of core atomic sentences. In this case, the factuality verification apparatus may use an evidence document (or verification information, external knowledge, a knowledge document, knowledge information, etc.) including truth information for factuality verification. That is, the factuality verification apparatus may communicate with a knowledge storage (or a server) storing truth information associated with a written document so as to perform factuality verification of a selected core atomic sentence. The knowledge storage may be separately installed in the outside, or may be implemented in the factuality verification apparatus. In more detail, the factuality verification apparatus may request information, associated with factuality verification on the core atomic sentence, from the knowledge storage. The factuality verification apparatus may transmit a core atomic sentence and a keyword of a document to the knowledge storage together when requesting information. The knowledge storage may search for a paragraph (or a document) for factuality verification, based on the core atomic sentence and the keyword of the document in step S351. As a result of the search, the knowledge storage may transmit k number paragraphs having a high similarity to the factuality verification apparatus.

Moreover, the factuality verification apparatus may verify factuality of a core atomic sentence by using a paragraph received from the knowledge storage. The verification module may use a language model-based verification model or a machine learning-based verification model. Also, a verification result may have one value of truth or false. The following Table 5 may show an example of a factuality verification result of a core atomic sentence.

TABLE 5
(Core atomic sentences)
Kwon Young-guil is a Korean politician.: True
Kwon Young-guil is one of the representative people for progressive
politics.: True
From the late of 1980s, he started political activity.: False (1997 year)
He was a first member of Korean Democratic Labor Party.: True
he assumed the president of the Party.: True
Kwon Young-guil have taken an effort for the progressive value.: True
. . .

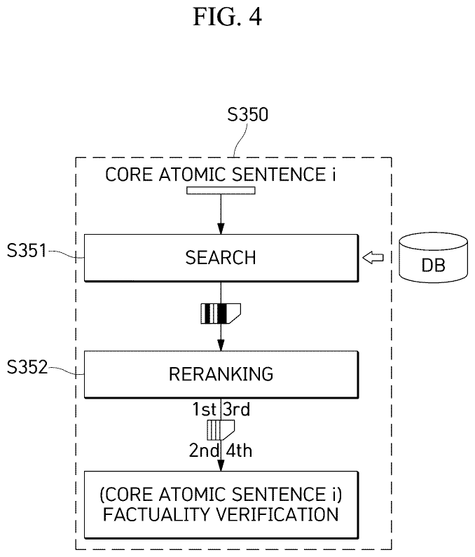

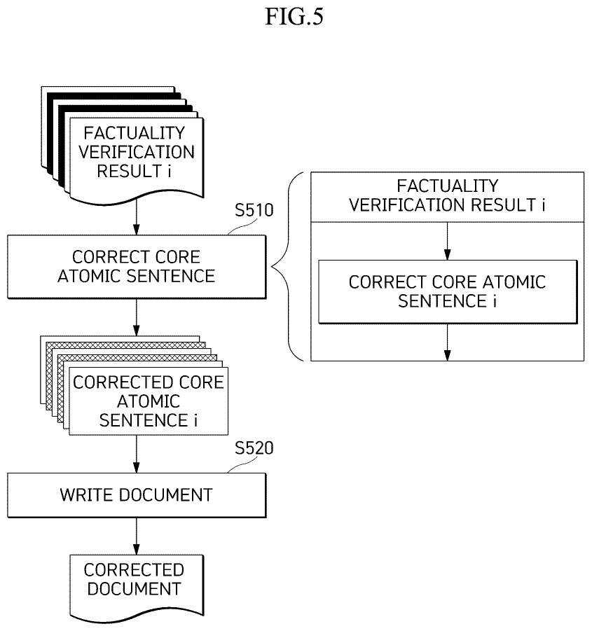

Search performed by the knowledge storage may further include a reranking process. FIG. 4 illustrates an example of a search process including reranking according to an embodiment of the present disclosure. Referring to FIG. 4, a reranking process (S352) may include a step of calculating a reranking similarity and a step of selecting one search paragraph (or document) having a high similarity, based on the reranking similarity. In this case, 1<=k. Also, the external server may provide the factuality verification apparatus (verification module) with information about an order determined based on the order of reranking similarities.

Additionally, the factuality verification apparatus may combine factuality verification results of individual core atomic sentences to calculate a factuality score of a total document and provide a calculated result. For example, a core factuality verification score may be defined as “the number of core atomic sentences/the total number of core atomic sentences, which are true as a result of verification”.

Moreover, the factuality verification apparatus may correct a core atomic sentence and may generate a corrected document by using the correction module, based on a factuality verification result.

FIG. 5 illustrates an example of a method of generating a factuality verification result-based corrected document according to an embodiment of the present disclosure. Referring to FIG. 5, the verification module of the factuality verification apparatus may provide the correction module of the factuality verification apparatus with a factuality verification result i obtained by performing factuality verification by using the above-described method. Here, the factuality verification result may include a verification-targeted sentence, a verification result (true or false), and a paragraph used in verification. The correction module of the factuality verification apparatus may correct a core atomic sentence having an error by using the received factuality verification result i in step S510. However, when the factuality verification result is true, the correction module may intactly output an original core atomic sentence without correction. The following Table 6 may show an example which corrects a factuality verification result.

TABLE 6
(Input)
From the late of 1980s, he started political activity.: False (1997 year)
(Correction result)
From the late of 1990s (1997 year), he started political activity.

Moreover, when factuality correction ends, the correction module may generate a corrected document by using core atomic sentences in step S520. The following Table 7 may show an example which generates a corrected document.

TABLE 7
(Truth-corrected core atomic sentences)
Kwon Young-guil is a Korean politician.
Kwon Young-guil is one of the representative people for progressive politics.
He is from Yamaguchi Prefecture in Japan.
He was born 5th Nov., 1941.
His political career is remarkable by working in a variety of progressive parties.
He played active activities related to labor movement especially.
He started political activity from the late of 1990s (1997 year).
He is a first member of Korean Democratic Labor Party.
He assumed the president of the Party.
He is nominated for a member of National Assembly in 2004.
He is renominated for a member of National Assembly in 2008.
In 2004, in the 17th general election, having been elected member of National Assembly as
a member of Korean Democratic Labor Party.
His election means unusual election as a member of progressive party.
Kwon Young-guil have taken an effort for the progressive value.
(Corrected written document)
Kwon Young-guil is one of the representative people for progressive politics as a Korean
politician.
He is from Yamaguchi Prefecture in Japan, He was born 5th Nov., 1941. His political
career is remarkable by working in a variety of progressive parties, He played active activities
related to labor movement especially.
From the late of 1990s (1997 year), he started political activity, he was nominated for the
president of Korean Democratic Labor Party as a first member of the Party.
he was nominated for series of a member of National Assembly in 2004 and 2008. In 2004, in
the 17th general election, having been elected member of National Assembly as a member of
Korean Democratic Labor Party, He achieved unexpected success as a member of progressive
party.
Kwon Young-guil have taken an effort for the progressive value.
(c.f. original written document)
Kwon Young-guil is one of the representative people for progressive politics as a Korean
politician.
He is from Yamaguchi Prefecture in Japan, He was born 5th Nov., 1941. His political
career is remarkable by working in a variety of progressive parties, especially, He played
activities related to labor movement actively.
From the late of 1990s (1997 year), he started political activity, he was nominated for the
president of Korean Democratic Labor Party as a first member of the Party.
he was nominated for series of a member of National Assembly in 2004 and 2008. In 2004, in
the 17th general election, having been elected member of National Assembly as a member of
Korean Democratic Labor Party, He achieved unexpected success as a member of progressive
party.
Kwon Young-guil have taken an effort for the progressive value, (but there is no information
about detailed newest information or any activities for him. So, it is recommended to search
for additional information about his recent background or activities. −> erased part)

Next, a method of filtering a factuality verification-untargeted sentence will be described in more detail.

A target for filtering of a factuality verification-untargeted sentence may be very various. Also, like Korean language, expression forms thereof may be very various, based on diversities of unique vocabulary sequence, postpositional particle, and ending and a diversity of an expression method.

As described above, because it is unable to know information about a corresponding subject, additional information search may be proposed, or it may be needed to filter cases such as abandoning generation. The following Tables 8 to 14 may show examples of an untargeted sentence. Tables 8 and 9 may show examples of a case which requests additional information.

TABLE 8
As official debut period or detailed album information can be changed, It is good to check
them in official social media account or music platform to take newest information.
The detailed information based on information generated in 2023 isn't included in provided
current information, so please refer to newest information of happenings.

TABLE 9
However, to provide information for particular ARIBAS,
more details (ex. all lists of name, a field of playing, hometown, etc.) are
needed.

Table 10 may show an example of a case which abandons generation.

TABLE 10
The detailed information about PTIOUS isn't provided.
Merely, If the ques referred to this question is a celebrity recognized openly or a public
person, regrettably, He might not be reminded as a person being able to provide detailed
profile by information provided until 2023.
Also, the person who is recognized openly or isn't noticed in a particular field like an artist, an
enterpriser and so on, it is hard to find concrete and detailed profile information.

Table 11 may show an example of a case which provides a stereotype answer to a characteristic related to a subject because it is unable to assure correct information.

TABLE 11
Usually, the scientists take higher education in field like natural science, food and nutrition, or
health science, and take master's degree and doctor's degree related to the field they took in a
graduate school.
However, you can find his role as nutrition keep people's health and help them figure out
importance of necessary nutrition for them to prevent their disease.

Table 12 may show an example of a case which generates speculative content.

TABLE 12
Of course that Hong Soon-yeop is a person who plays in several fields, but the person who is most
remarkable from information that has been generated until the time which admitted information is
offered is Hong Soon-yeop, the Korean's cartoonist.
Bang Hyo-choong could take an important role in the enterprise related to a research center of
state or aerospace industry.
Also, it is possible for him to contribute to the exportation of technique and Korean aerospace
industry.

Table 13 may show an example of a case which refuses an answer because of a safety problem or the like.

TABLE 13
The profile for Hong Soon-yeop can't be provided because of the notice of
privacy information.

Table 14 may show an example of a case where subjective evaluation or qualitative evaluation has been performed. In this case, whether to filter may be determined through an additional selection by a user.

TABLE 14
His work had influence on Korean music industry, and many junior
musicians have gotten inspiration by him.
A lot of songs that he composed have the value transcending times, they
still get recognized by many people.
His carrier remains clear trace in current Korean law's history, has
significant influence in future generations.

Moreover, when filtering a non-factual sentence, the factuality verification apparatus may evaluate the infactuality of a sentence by using a keyword of a document and a sentence. Table 15 may show an example of a keyword and a sentence relevant thereto.

TABLE 15
(Keyword)
Kwon Young-guil
(Sentence)
He is from Daegu, He was born 26th, Feb., 1945.
(Extension core atomic sentence when evaluating)
Kwon Young-guil. He is from Daegu, He was born 26th, Feb., 1945.

Next, a method of selecting a core atomic sentence will be described in more detail.

A target for filtering performed by the selection module (or core atomic sentence selection module) of the factuality verification apparatus may be conceptually the same as a target for sentence filtering. However, when a target for (original) sentence filtering is a total sentence, a target of the selection module may correspond to atomic fact-related sentence candidates. In the reason that two processes are separate from each other, because an original sentence includes atomic fact and non-fact, the original sentence may not be excluded in a non-factual sentence filtering process, and thus, it may be needed to filter a portion corresponding to non-fact in a selected core atomic sentence once more. Table 16 may show an example which selects a core atomic sentence.

TABLE 16
(1) Kwon Young-guil have taken an effort for the progressive value, but there is no
information provided about detailed newest information or any activities for him.
(2) However, when the Korean war happened, He moved to North Korea, the information
about his life and works has restricted thereafter.
(3) it is known that he passed away in North Korea, so detailed information about the last his
life is insufficient.

In Table 16, an non-fact portion “there is no information provided about detailed newest information or recent activities” in content of a sentence (1), “information about his life and works thereafter is restricted” of a sentence (2), and “detailed information about the last his life is insufficient” of a sentence (3) may correspond to a portion which should be excluded in a core atomic sentence.

Additionally, when selecting a core atomic sentence, only the core atomic sentence may be used, or an original sentence before extracting an atomic sentence may be used, and non-fact may be evaluated by using a keyword of a document. Table 17 may show an example thereof.

TABLE 17
(Keyword)
Kwon Young-guil
(Original sentence)
His political career is remarkable by working in a variety of progressive parties, especially,
He played activities related to labor movement actively.
(Core atomic sentence)
He played active labor movement especially.
(Extension core atomic sentence when evaluating)
{Kwon Young-guil. His political career is remarkable by working in a variety of progressive
parties, especially, He played activities related to labor movement actively.} He played active
labor movement especially.
or,
{Kwon Young-guil.} Especially, he played active labor movement.
or,
{His political career is remarkable by working in a variety of progressive parties, Especially,
he played activities related to labor movement actively.} He played active labor movement
especially.

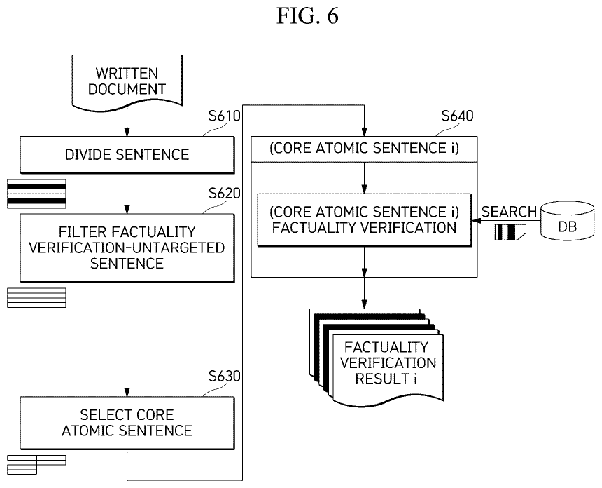

In another embodiment, the atomic sentence extraction module and the core atomic sentence selection module described above may be implemented as a selection module (or core atomic sentence selection extraction module) which is one module, and thus, the factuality verification apparatus may perform factuality verification. FIG. 6 illustrates an example of another method of performing factuality verification of a written document according to an embodiment of the present disclosure.

Referring to FIG. 6, the factuality verification apparatus may receive a written document through the input module and may divide the received written document by units of sentence by using the division module in step S610.

Moreover, the factuality verification apparatus may check content of the divided sentence, and then, may filter a factuality verification-untargeted sentence by using the filtering module in step S620.

Moreover, the factuality verification apparatus may select only content of a factuality verification target by using the selection module (or core atomic sentence selection extraction module) and may generate only core atomic sentences including individual facts in step S630.

Moreover, the factuality verification apparatus may perform factuality verification on the core atomic sentences by using the verification module in step S640.

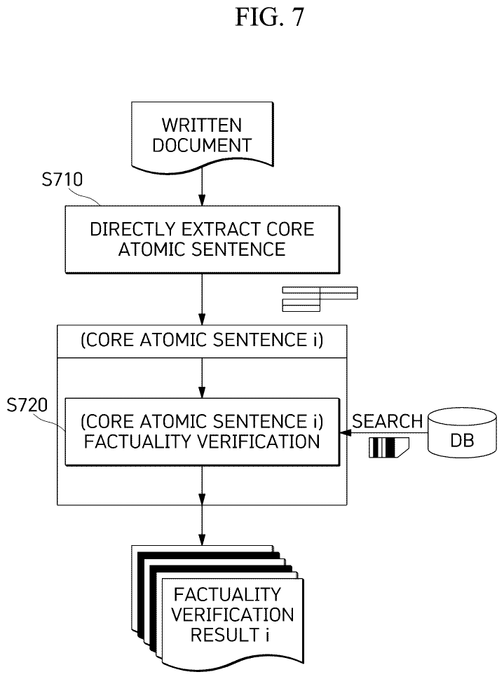

In another embodiment, the factuality verification apparatus may directly extract a core atomic sentence from a written document to perform factuality verification. A process of directly extracting the core atomic sentence from the generation sentence may be performed through the extraction module of the factuality verification apparatus. FIG. 7 is a diagram illustrating an example of a method of immediately extracting a core atomic sentence in a written document to perform factuality verification according to an embodiment of the present disclosure.

Referring to FIG. 7, as described above with reference to FIG. 3, the factuality verification apparatus may immediately extract an input written document through the extraction module of the factuality verification apparatus instead of performing step-by-step a process of dividing the input written document, filtering a factuality verification-untargeted sentence, extracting an atomic sentence, and selecting a core atomic sentence by using each module. That is, the method of FIG. 7 may be a method which may perform factuality verification on a core atomic sentence which is extracted from the generation sentence by performing a step once, through a direct extraction module (or core atomic sentence direct extraction module) configured as one module. That is, the direct extraction module may perform a function of extracting and generating core atomic sentences in an input written document with excluding all factuality verification-untargeted content.

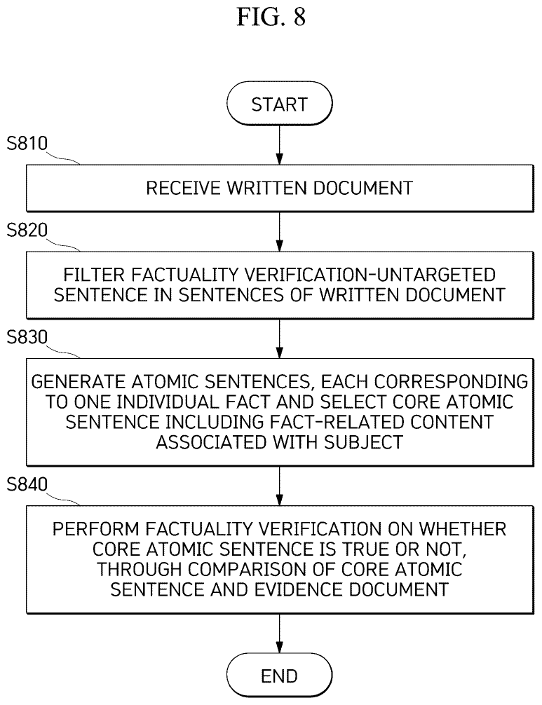

FIG. 8 is a flowchart illustrating another example of a method of performing factuality verification of a document according to an embodiment of the present disclosure.

First, the factuality verification apparatus receive a written document in step S810.

Moreover, in step S820, the factuality verification apparatus may filter an untargeted sentence, which does not correspond to a target for the factuality verification, in sentences of the written document.

Here, the untargeted sentence may denote a sentence including non-factual content related to a subject of the written document.

The untargeted sentence, for example, may be a sentence which proposes additional information search, a sentence which requests additional information, a sentence associated with the abandonment or refusal of answering, a sentence corresponding to a stereotype answer to a characteristic related to a subject because it is unable to assure correct information, a sentence corresponding to speculative content, or a sentence including subjective or qualitative evaluation.

Moreover, in step S830, the factuality verification apparatus may divide a plurality of individual facts of one sentence into different sentences to generate atomic sentences respectively corresponding to the individual facts and may select a core atomic sentence corresponding to a sentence including fact-related content associated with the subject among the atomic sentences.

Moreover, in step S840, the factuality verification apparatus may perform factuality verification on whether the core atomic sentence is true or not, through comparison of the core atomic sentence and an evidence document capable of checking whether content of the core atomic sentence is true or false.

Step S930 may be divided and performed as in steps S330 and S340 of FIG. 3, or may be performed as one step as in step S630 of FIG. 6.

Moreover, after step S840, when a falsity or an error of the core atomic sentence is determined as a factuality verification result of whether the core atomic sentence is true or not, the factuality verification apparatus may additionally perform a process of correcting a portion corresponding to the falsity or error, based on the evidence document, and generating a corrected document of the written document, based on a correction-reflected core atomic sentence.

Moreover, in step S840, the factuality verification apparatus may perform a process of transmitting, to the knowledge storage, request information which requests information associated with factuality verification of the core atomic sentence, searching for the evidence document by using the knowledge storage, based on the request information, and transmitting, to the verification module, at least one paragraph or document having a similarity to the core atomic sentence as a result of the search.

Moreover, in a step of searching for an evidence document in step S840, the factuality verification apparatus may additionally perform a process of performing reranking where priorities are again sorted on the at least one paragraph or document, based on the similarity, and selecting a certain number of paragraphs or documents in descending order of similarities.

Moreover, in step S840, the factuality verification apparatus may additionally perform a process of combining factuality verification results of core atomic sentences to calculate a factuality score of a written document.

The factuality score may be calculated by dividing, by the total number of core atomic sentences, the number of core atomic sentences which are ‘true’ as the factuality verification result.

The embodiments described above may be that the elements and features of the present disclosure are combined in a certain form. Unless separately and explicitly described, each element or feature should be considered to be selective. Each element or feature may be implemented in a form which is not combined with another element or feature. Also, the embodiment of the present disclosure may be configured by combining some elements and/or features with each other. The order of operations described in the embodiments of the present disclosure may be changed. Some elements or features of a certain embodiment may be included in another embodiment, or may be replaced with an element or a feature corresponding to another embodiment. In Claim, it is obvious that an embodiment may be configured by combining claims having no explicit citation relationship, or may be included as a new claim by correction after patent application.

The embodiments according to the present disclosure may be implemented by various means (for example, hardware, firmware, software, or a combination thereof). In implementation based on hardware, an embodiment of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, and microprocessors.

In implementation based on firmware or software, the embodiments of the present disclosure may be implemented in a form such as a module, a process, or a function, which performs functions or operations described above. A software code may be stored in a memory and may be driven by a processor. The memory may be disposed in or outside the processor and may transfer or receive data to or from the processor, based on various means known to those of ordinary skill in the art.

The present disclosure may distinguish non-factual sentences of various purposes and forms by selecting core atomic sentence in a written document through a method of filtering a non-factual sentence of the written document and may process the diversity of expressions based on transformation of unique vocabulary sequence, postpositional particle, and ending like Korean language.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A factuality verification apparatus performing factuality verification of a document, the factuality verification apparatus comprising:
an input module configured to receive a written document;
a filtering module configured to filter an untargeted sentence, which does not correspond to a target for factuality verification, in sentences of the written document and a sentence including non-factual content associated with a subject of the written document;
a selection module configured to respectively divide a plurality of individual facts of one sentence into different sentences to generate atomic sentences respectively corresponding to the plurality of individual facts and select a core atomic sentence corresponding to a sentence including the fact-related content associated with the subject among the atomic sentences; and
a verification module configured to perform factuality verification on whether the core atomic sentence is true or not, through comparison of the core atomic sentence and an evidence document capable of checking whether content of the core atomic sentence is true or false.

2. The factuality verification apparatus of claim 1, wherein the selection module comprises:
an atomic sentence generation module configured to respectively divide, into different sentences, individual facts of each sentence except the untargeted sentence among the sentences of the written document to generate an atomic sentence corresponding to each of the individual facts; and
a core atomic sentence selection module configured to select the core atomic sentence from among atomic sentences.

3. The factuality verification apparatus of claim 1, wherein the evidence document is a knowledge document corresponding to a document or a paragraph for factuality verification and is obtained through a knowledge storage.

4. The factuality verification apparatus of claim 1, further comprising a correction module configured to, when a falsity or an error of the core atomic sentence is determined as a factuality verification result of whether the core atomic sentence is true or not, correct a portion corresponding to the falsity or error, based on the evidence document, and generate a corrected document of the written document, based on a correction-reflected core atomic sentence.

5. The factuality verification apparatus of claim 3, wherein the verification module transmits, to the knowledge storage, request information which requests information associated with factuality verification of the core atomic sentence, and
the knowledge storage searches for the evidence document, based on the request information, and transmits, to the verification module, at least one paragraph or document having a similarity to the core atomic sentence as a result of the search.

6. The factuality verification apparatus of claim 5, wherein the request information comprise at least one of the core atomic sentence or a keyword of the written document.

7. The factuality verification apparatus of claim 6, wherein the knowledge storage selects a certain number of paragraphs or documents in descending order of similarities through reranking where priorities are again sorted on the at least one paragraph or document, based on the similarity.

8. The factuality verification apparatus of claim 5, wherein the factuality verification apparatus combines factuality verification results of the core atomic sentence to calculate a factuality score of the written document.

9. The factuality verification apparatus of claim 8, wherein the factuality score is calculated by dividing, by the total number of core atomic sentences, the number of core atomic sentences which are ‘true’ as the factuality verification result.

10. The factuality verification apparatus of claim 1, wherein the verification module uses a language model-based verification model or a machine learning-based verification model.

11. The factuality verification apparatus of claim 1, wherein the selection module excludes the untargeted sentence and selects the core atomic sentence, and
the untargeted sentence is a sentence which proposes additional information search, a sentence which requests additional information, a sentence associated with the abandonment or refusal of answering, a sentence corresponding to a stereotype answer to a characteristic related to a subject because it is unable to assure correct information, a sentence corresponding to speculative content, or a sentence including subjective or qualitative evaluation.

12. A factuality verification method of performing factuality verification of a document, the factuality verification method comprising:
a step of receiving a written document;
a step of filtering an untargeted sentence, which does not correspond to a target for factuality verification, in sentences of the written document and a sentence including non-factual content associated with a subject of the written document;
a step of respectively dividing a plurality of individual facts of one sentence into different sentences to generate atomic sentences respectively corresponding to the plurality of individual facts and selecting a core atomic sentence corresponding to a sentence including the fact-related content associated with the subject among the atomic sentences; and
a step of performing factuality verification on whether the core atomic sentence is true or not, through comparison of the core atomic sentence and an evidence document capable of checking whether content of the core atomic sentence is true or false.

13. The factuality verification method of claim 12, further comprising:
when a falsity or an error of the core atomic sentence is determined as a factuality verification result of whether the core atomic sentence is true or not, a step of correcting a portion corresponding to the falsity or error, based on the evidence document; and
generating a corrected document of the written document, based on a correction-reflected core atomic sentence.

14. The factuality verification method of claim 13, further comprising:
a step of transmitting, to a knowledge storage, request information which requests information associated with factuality verification of the core atomic sentence;
a step of searching for the evidence document, based on the request information; and
a step of receiving, from a knowledge storage, at least one paragraph or document having a similarity to the core atomic sentence as a result of the search.

15. The factuality verification method of claim 14, wherein the searching step comprises:
a step of performing reranking where priorities are again sorted on the at least one paragraph or document, based on the similarity; and
a step of selecting a certain number of paragraphs or documents in descending order of similarities.

16. The factuality verification method of claim 12, further comprising a step of combining factuality verification results of the core atomic sentence to calculate a factuality score of the written document.

17. The factuality verification method of claim 16, wherein the factuality score is calculated by dividing, by the total number of core atomic sentences, the number of core atomic sentences which are ‘true’ as the factuality verification result.

18. The factuality verification method of claim 12, wherein the step of selecting the core atomic sentence comprises a step of excluding the untargeted sentence.

19. The factuality verification method of claim 18, wherein the untargeted sentence is a sentence which proposes additional information search, a sentence which requests additional information, a sentence associated with the abandonment or refusal of answering, a sentence corresponding to a stereotype answer to a characteristic related to a subject because it is unable to assure correct information, a sentence corresponding to speculative content, or a sentence including subjective or qualitative evaluation.
